(19) United States
(12) Patent Application Publication
(10) Pub. No.: US 2026/0200668 A1
(43) Pub. Date: Jul. 16, 2026

(54) BELT GUIDES FOR REFUSE VEHICLE LIFT ARM

(71) Applicant: The Heil Co., Chattanooga, TN (US)

(72) Inventors: Phillip A. Kendrick, Chattanooga, TN (US); Marc Nadeau, Levis (CA); Michel Fillion, Beaumont (CA)

(21) Appl. No.: 19/451,467

(22) Filed: Jan. 16, 2026

Related U.S. Application Data
(60) Provisional application No. 63/746,003, filed on Jan. 16, 2025.

(51) Int. Cl. B65F 3/08; B65F 3/02

(52) U.S. Cl. CPC B65F 3/08; B65F 2003/023; B65F 2003/0269

(57) ABSTRACT

A refuse loading system includes a belt system with belt guides for inhibiting slippage of a belt relative to a pulley. The refuse loading system can include a container lift mechanism and a grabber system. The grabber system can be operable to engage a refuse container, and the container lift mechanism can raise and lower the grabber system. The belt system, which can be part of the container lift mechanism, can include a belt and pulley arrangement. The grabber system can be attached to a central region of the belt so that it can be raised and lowered along a mast. The belt guides can include a first belt guide that overlaps a first edge region of the belt, and a second belt guide that overlaps a second edge region of the belt. The first belt guide and the second belt guide can be spaced apart by a gap.

### CROSS-REFERENCE TO RELATED APPLICATION

This application claims the benefit under 35 U.S.C. § 119(e) of U.S. Patent Application No. 63/746,003, entitled “Belt Guides For Refuse Vehicle Lift Arm,” filed January 16, 2025, which is incorporated herein by reference in its entirety.

### BACKGROUND

Refuse collection vehicles are typically used to pick up quantities of refuse (e.g., garbage, waste, recyclables, etc.) for hauling to a designated area, such as a landfill, transfer station, or material recovery facility. Some refuse vehicles include a refuse loading system to transfer refuse from refuse containers into a receptacle of the refuse vehicle.

### SUMMARY

Aspects of this disclosure are directed to vehicles, systems, and techniques that facilitate refuse collection.

In one aspect, a system for loading refuse includes: a grabber system operable to engage a refuse container, and a container lift mechanism configured to couple between the grabber system and a refuse collection vehicle. The container lift mechanism is operable to lift the refuse container held by the grabber system. The container lift mechanism includes a mast and a belt system. The belt system includes: a pulley, a belt, one or more drive units, a first belt guide, and a second belt guide. The pulley is coupled with the mast and is rotatable about a rotational axis. The belt is engaged with the pulley. The grabber system is coupled to a portion of the belt that extends along a longitudinal axis of the mast. A width of the belt, in a direction parallel to the rotational axis of the pulley, includes: a first edge region, a second edge region, and a central region extending between the first edge region and the second edge region. The one or more drive units are configured to drive the belt system such that the pulley rotates and moves the belt, and the grabber system is configured to move together with the belt. The first belt guide overlaps the first edge region of the belt. The second belt guide overlaps the second edge region of the belt. In the direction parallel to the rotational axis of the pulley, the first belt guide and the second belt guide are spaced apart by a gap.

In another aspect combinable with the previous aspect, the belt system is a belt guide assembly that includes the first belt guide and the second belt guide, and the central region of the belt is not covered by the belt guide assembly. In this aspect, the belt guide assembly limits movement of the belt, relative to the pulley, in a radial direction orthogonal to the rotational axis of the pulley.

In another aspect combinable with one or more of the previous aspects, the belt includes a first side and a second side. The first side engages the pulley. The second side faces away from the pulley. The first belt guide includes an underside proximate the first edge region. The second side of the belt and the underside face each other. In some implementations, the pulley is a timing pulley, the belt is a timing belt, and the first side of the timing belt includes teeth that engage grooves of the timing pulley. According to some examples, the teeth have a tooth height dimension in a direction orthogonal to the rotational axis, and the underside of the first belt guide is spaced apart from the second side of the timing belt by a gap distance that is less than the tooth height dimension. In some examples, the underside of the first belt guide is in contact with the second side of the timing belt.

According to some implementations, the belt system further includes an interface element coupled with the underside of the first belt guide. The interface element is configured to provide a barrier that inhibits the ingress of debris into at least a portion of the belt system. In some examples, the interface element includes a brush material, a gasket, and/or a ball bearing, etc.

In some implementations, the timing pulley is a first timing pulley, and the belt system further includes a second timing pulley coupled to the mast and located below the first timing pulley.

In some implementations, the grabber system is fixedly attached to the central region of the timing belt. Furthermore, in some implementations, the mast further includes vertical rails including guides configured to guide the grabber system on the mast. The vertical rails include a first vertical rail and a second vertical rail. The first vertical rail is proximate the first edge region of the timing belt. The second vertical rail is proximate the second edge region of the timing belt.

In another aspect combinable with one or more of the previous aspects, the first belt guide and the second belt guide are tapered such that they form a spaced-apart V-shape.

In one aspect, a refuse collection vehicle includes: a cab, a vehicle chassis coupled to the cab, and a refuse body coupled to and supported on the chassis. The refuse body includes a refuse collecting space and a refuse loading system for loading refuse into the refuse collecting space. The refuse loading system includes a grabber system and a container lift mechanism. The grabber system is operable to engage a refuse container. The container lift mechanism is configured to couple between the grabber system and the refuse collection vehicle and is operable to lift the refuse container held by the grabber system. The container lift mechanism includes a mast and a belt system. The belt system includes: a pulley, a belt, one or more drive units, a first belt guide, and a second belt guide. The pulley is coupled with the mast and is rotatable about a rotational axis. The belt is engaged with the pulley. The grabber system is coupled to a portion of the belt that extends along a longitudinal axis of the mast. A width of the belt, in a direction parallel to the rotational axis of the pulley, includes: a first edge region, a second edge region, and a central region extending between the first edge region and the second edge region. The one or more drive units are configured to drive the belt system such that the pulley rotates and moves the belt. The grabber system is configured to move together with the belt. The first belt guide overlaps the first edge region of the belt. The second belt guide overlaps the second edge region of the belt. In the direction parallel to the rotational axis of the pulley, the first belt guide and the second belt guide are spaced apart by a gap.

In another aspect combinable with the previous aspect, the belt system is a belt guide assembly that includes the first belt guide and the second belt guide. The central region of the belt is not covered by the belt guide assembly.

In another aspect combinable with one or more of the previous aspects, the belt includes a first side and a second side. The first side engages the pulley. The second side faces away from the pulley. The first belt guide includes an underside proximate the first edge region. The second side of the belt and the underside face each other. In some implementations, the pulley is a timing pulley, the belt is a timing belt, and the first side of the timing belt includes teeth that engage grooves of the timing pulley. According to some examples, the teeth have a tooth height dimension in a direction orthogonal to the rotational axis, and the underside of the first belt is spaced apart from the second side of the timing belt by a gap distance that is less than the tooth height dimension.

Particular implementations of the subject matter described in this specification can be implemented so as to help improve operational reliability, avoid vehicle damage, and reduce vehicle downtime. For example, implementations of the belt guides described herein function to constrain a belt and mechanically prevent it from jumping teeth of a drive pulley. Without such belt guides, it would be possible for the belt to slip/skip relative to teeth of the drive pulley. If slippage occurs (e.g., when driving a lift arm up/down or in/out), it is possible to lose the location of the grabber system; and it could allow collisions between a belt attachment device (used for attaching the grabber system to the belt) and the drive pulley.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is an example refuse vehicle that includes a refuse loading system with belt guides, in accordance with some implementations.

FIG. 2 is a perspective view of an example refuse loading system that includes belt guides, in accordance with some implementations.

FIGS. 3A-3E are views of an example belt guide arrangement that can be included in a refuse loading system, in accordance with some implementations. FIG. 3A shows a front perspective view of the belt guide arrangement. FIG. 3B shows a front view of the belt guide arrangement. FIG. 3C shows a back perspective view of the belt guide arrangement. FIG. 3D shows a top view of the belt guide arrangement. FIG. 3E shows a perspective cross-sectional view of the belt guide arrangement.

FIG. 4 is a schematic cross-sectional view of an example belt guide arrangement that includes one or more interface elements, in accordance with some implementations.

FIG. 5 is a perspective view of an example refuse container emptying system that includes belt guides, in accordance with some implementations.

FIG. 6 is a side view of an example refuse container emptying system that includes belt guides, in accordance with some implementations.

FIG. 7 is a cross-sectional view of an example timing belt system of a container lift mechanism that includes belt guides, in accordance with some implementations.

FIGS. 8A-8E are a series of perspective and exploded views that illustrate an example connection of a grabber system to a timing belt system of a container lift mechanism that can include belt guides, in accordance with some implementations. FIG. 8A shows a perspective view of the grabber system and a belt attachment device. FIG. 8B shows a perspective view of the grabber system connected to the timing belt system via the belt attachment device. FIG. 8C shows a perspective view of the belt attachment device connecting the grabber system to the timing belt system. FIG. 8D shows a perspective view of the belt attachment device on a timing belt. FIG. 8E shows an exploded view of the belt attachment device.

FIG. 9 is a perspective view of an example upper portion of a timing belt system of a refuse loading system with belt guides, in accordance with some implementations.

FIG. 10 is a perspective view of an example upper timing pulley of a container lift mechanism that can be included in a refuse loading system with belt guides, in accordance with some implementations.

FIGS. 11A-11C are a series of side cross-sectional views that illustrate an example of raising a grabber system on a refuse container lift mechanism that can be included in a refuse loading system with belt guides, in accordance with some implementations.

FIG. 12 is a perspective view of an example mast of a container lift mechanism that can be included in a refuse loading system with belt guides, in accordance with some implementations.

FIG. 13 is a cross-sectional view of an example lower timing pulley of a container lift mechanism that can be included in a refuse loading system with belt guides, in accordance with some implementations.

### DETAILED DESCRIPTION

Implementations of the present disclosure are directed to systems, devices, and methods for loading refuse using a refuse loading system that includes belt guides. In the context of a refuse vehicle, a belt system is part of a refuse loading system in various implementations. The refuse loading system can include a refuse container emptying system, which can include a container lift mechanism and a grabber. The grabber can be operated to engage a refuse container (e.g., to selectively grab/hold/release the refuse container), and the container lift mechanism can be operated to lift the grabber (e.g., together with the refuse container) to lift the refuse container and tip and dump its contents into a hopper of the refuse vehicle. The belt system can include a belt engaged with a pulley. The grabber can be attached to the belt, and the belt system can be used to move the grabber along a mast of the container lift mechanism. In various implementations, the belt system includes belt guides configured to inhibit slippage of the belt relative to the pulley.

In some examples, the pulley is a timing pulley, and the belt is a timing belt with teeth that engage grooves of the timing pulley. The belt guides can be used to limit movement of the timing belt in a radial direction orthogonal to the rotational axis of the timing pulley, e.g., so that the teeth of the timing belt remain engaged with the corresponding teeth/grooves of the timing pulley, even under loads that would otherwise tend to cause the timing belt to lift away from the timing pulley.

Under high loads, it is possible for a timing belt to slip relative to teeth of a drive pulley. If slippage occurs (e.g., when driving a lift arm up/down or in/out), it is possible to lose the location of the grabber system; and it could allow collisions between a belt attachment device (used for attaching the grabber system to the belt) and the drive pulley. For the belt to slip, the belt must lift away from the drive pulley around the entire contact area by two times the tooth height of the belt. An event that causes this type of lifting action can allow the belt to slip more than one tooth.

The belt guides described herein can be non-contact guides that are spaced about 0.25 times the tooth height away from the belt in some implementations. Such belt guides function to constrain the belt and mechanically prevent it from jumping teeth. The term “about” in this disclosure, when used to describe a numerical range or value, references a margin within ± 5% of the stated value or range. In some implementations, the belt guides can be spaced apart from the belt by a distance ranging between 0 to 1 times the tooth height, such as between 0 to 0.5 times the tooth height, and/or between 0 to 0.25 times the tooth height. In these ranges, the lower limit of 0 times the tooth height corresponds to the belt guides being in contact with the belt.

The belt guides described herein can include a first belt guide that overlaps a first edge region of the belt, and a second belt guide that overlaps a second edge region of the belt. The first belt guide and the second belt guide are spaced apart by a gap. The gap can allow the grabber system to move with the belt along the mast of the container lift mechanism without interference by the belt guides.

Systems described herein can be configured to prevent “tenting” of the belt. Tenting can refer to the central region of the belt rising relative to the edge regions of the belt, resembling a tent shape. Tenting can result in the belt slipping. Systems described herein include configurations in which the belt is sufficiently stiff and/or configurations in which the tension of the belt is sufficiently high across the span of the belt to prevent tenting. As discussed in further detail herein, some implementations include a configuration in which the grabber system is attached to the central region of the belt, and rollers on either side of the grabber system engage with roller guides on either side of the mast, which can ensure a sufficient load is constantly applied to the central region of the belt, thereby preventing tenting.

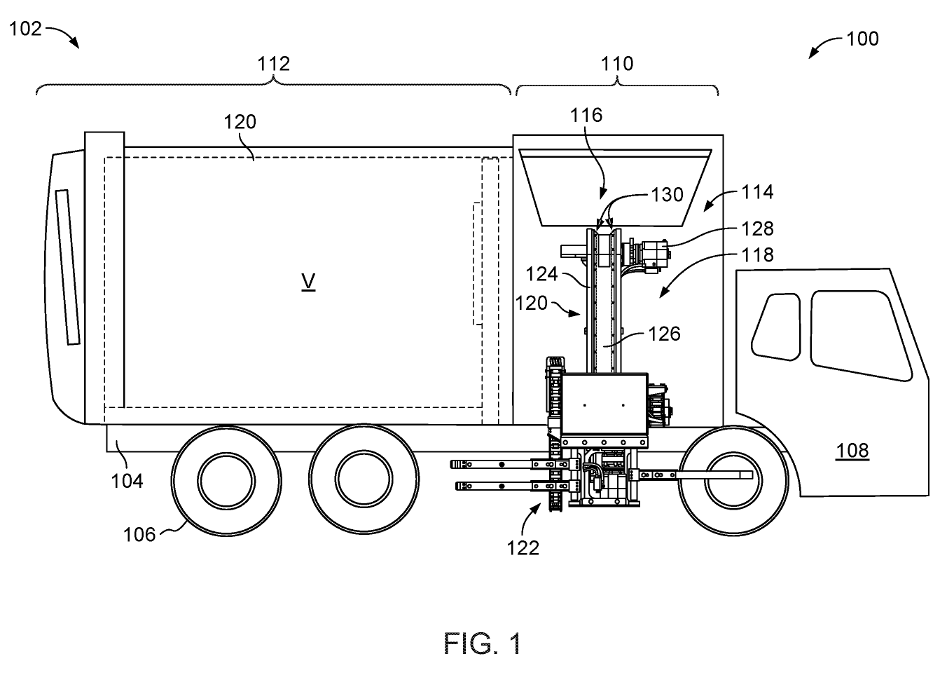

FIG. 1 illustrates an example refuse vehicle that includes a refuse loading system with belt guides. Refuse vehicle 100 includes waste collection device 102, frame 104, wheels 106, and cab 108. Waste collection device 102 includes waste intake portion 110 and waste storage portion 112.

Waste intake portion 110 includes refuse loading system 114 and hopper 116. Refuse loading system 114 is operable to transfer the contents of refuse containers into waste collection device 102 via hopper 116. Waste collection device 102 can include a packing device (not shown in FIG. 1). The packing device can pack refuse loaded into the hopper 116, push refuse toward the rear of the refuse vehicle 100 (e.g., to waste storage portion 112), and/or eject refuse from the refuse vehicle 100.

Refuse loading system 114 includes refuse container emptying system 118. Refuse container emptying system 118 includes container lift mechanism 120 and grabber 122. Grabber 122 can be operated to couple to a refuse container. Container lift mechanism 120 can be operated to lift the refuse container and tip and dump contents of the refuse container into hopper 116.

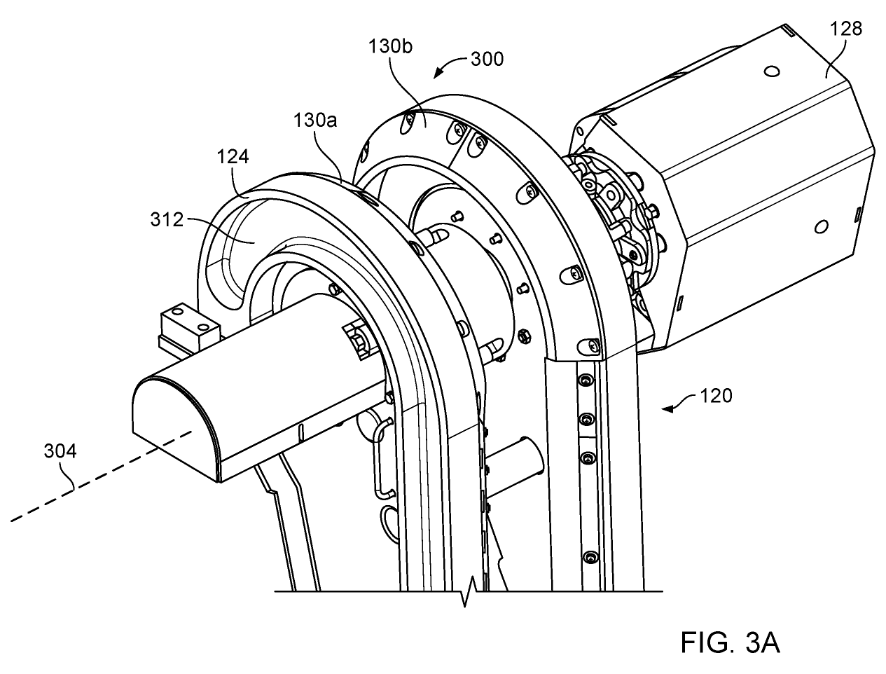

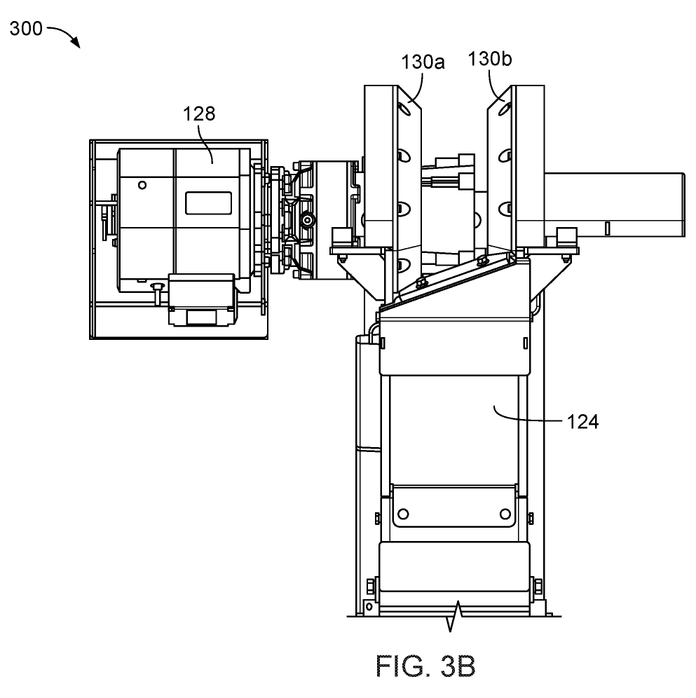

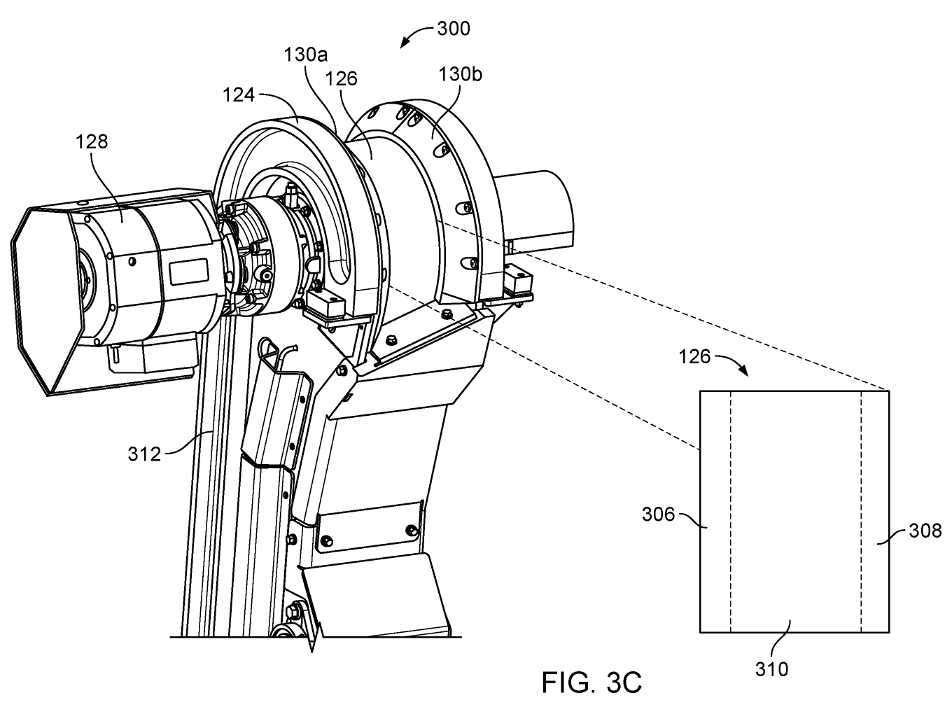

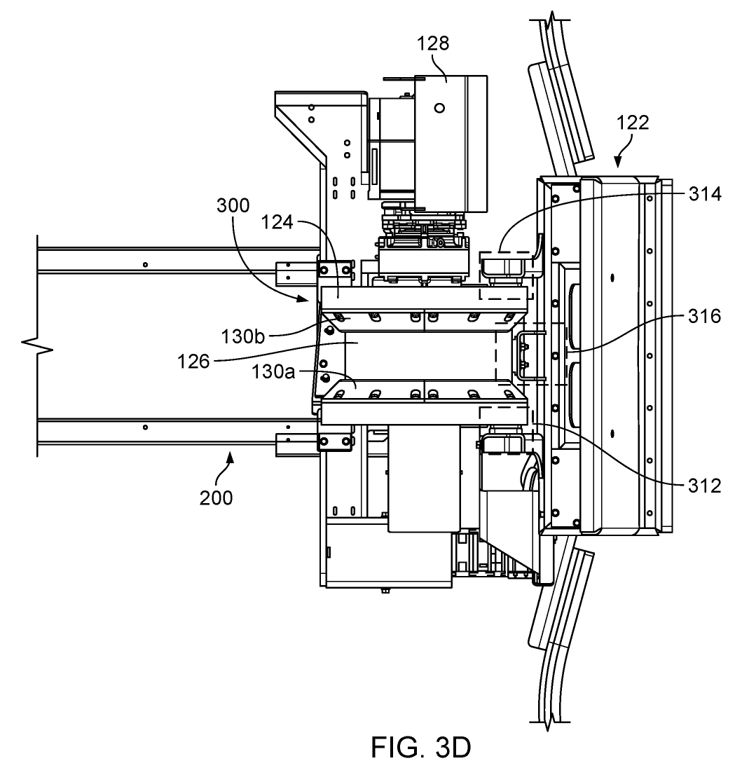

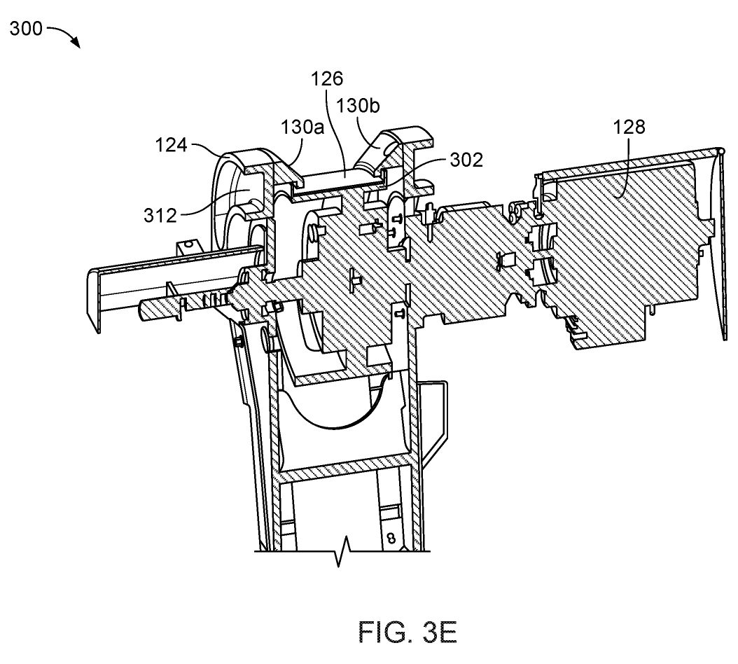

As will be discussed in greater detail herein, the container lift mechanism 120 includes a mast 124 and a belt system. The belt system includes one or more pulleys (e.g., pulley 302 in FIG. 3E), a belt 126, one or more drive units 128, and belt guides 130. The belt guides 130 form a belt guide assembly that inhibits slippage of the belt 126 relative to the pulley. Belt guides 130 overlap edge regions of the belt 126, leaving a central region of the belt 126 uncovered by the belt guide assembly.

Refuse vehicle 100 can be a refuse collection vehicle (RCV) that operates to collect and transport refuse (e.g., garbage). The refuse collection vehicle can also be described as a garbage collection vehicle, or garbage truck. Refuse vehicle 100 is configured to lift containers that contain refuse and empty the refuse in the containers into a hopper (e.g., hopper 116) of the refuse vehicle 100 and/or intermediate collection device conveyed by the RCV, to enable transport of the refuse to a collection site, compacting of the refuse, and/or other refuse handling activities. Refuse vehicle 100 can also handle containers in other ways, such as by transporting the containers to another site for emptying.

In some implementations, refuse vehicle 100 is an all-electric vehicle. Motive power and various body controls and sub-systems on the vehicle (including refuse loading system 114, a packing system, an ejector system, and/or a contamination detection system, etc.) can be electrically powered.

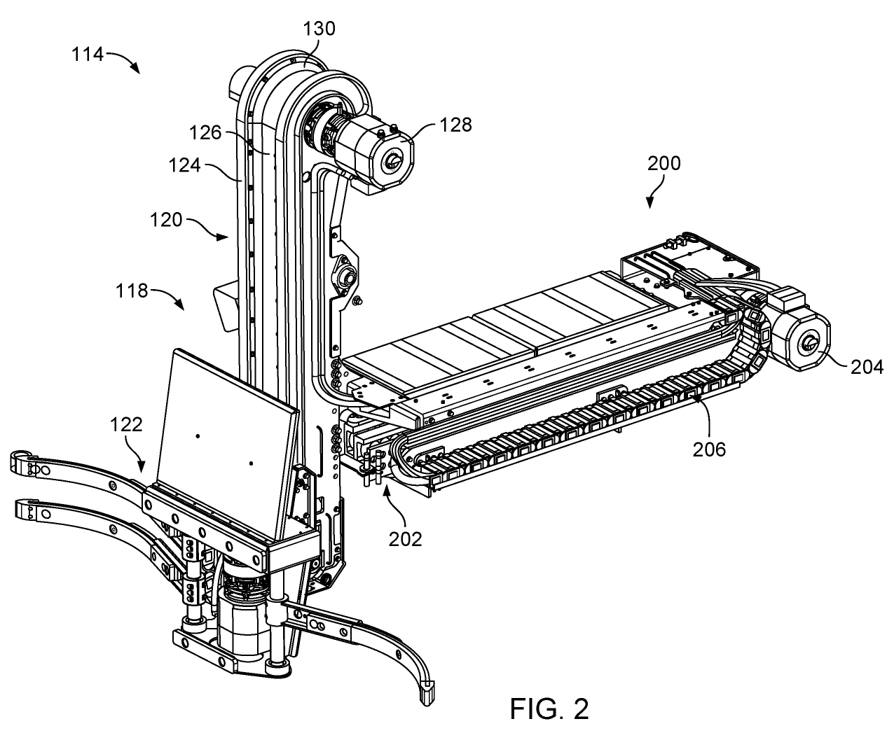

FIG. 2 is a perspective view of an example refuse loading system (e.g., refuse loading system 114 in FIG. 1) that includes belt guides (e.g., belt guides 130 in FIG. 1). Refuse loading system 114 includes horizontal positioning system 200 and refuse container emptying system 118. Refuse container emptying system 118 includes container lift mechanism 120 and grabber 122. Horizontal positioning system 200 is mounted to the frame of a refuse vehicle (e.g., refuse vehicle 100 in FIG. 1). Horizontal positioning system 200 can be operated to position refuse container emptying system 118 relative to the body of refuse vehicle. Horizontal positioning system 200 can have a retracted position and one or more extended positions. Horizontal positioning system 200 can be used to position refuse container emptying system 118 directly in front of a refuse container so that the refuse container can be lifted and its contents emptied into a hopper (e.g., hopper 116 in FIG. 1) of the refuse vehicle.

Horizontal positioning system 200 includes one or more translatable sections 202, a drive unit 204, and a conveyance system 206. Translatable section(s) 206 can include a base section assembly, an intermediate section assembly, and a distal section assembly. Base section assembly is mounted to the frame of the refuse vehicle. Horizontal positioning system 200 is installed such that it is partially or completely underneath the hopper of the refuse vehicle. Intermediate section assembly is translatably coupled with base section assembly. Distal section assembly is translatably coupled with intermediate section assembly. Refuse container emptying system 118 is mounted on distal section assembly. Conveyance system 206 can include, for example, one or more pulleys, belts, cables, rails, and/or rollers, etc. Drive unit 204 is used to drive conveyance system 206. Conveyance system 206 enables translation of one or more sections of the horizontal positioning system 200 relative to one or more other sections of the horizontal positioning system 200. As an example, intermediate section assembly can translate relative to the base section assembly via the conveyance system 206. As another example, distal section assembly can translate relative to the intermediate section assembly via the conveyance system 206.

Intermediate section assembly is coupled for translation in and out on base section assembly. In this manner, refuse container emptying system 118 can be alternately positioned farther from, or closer to, the body of refuse vehicle. For example, refuse container emptying system 118 can be extended out to where a curb-side refuse container is situated for pick up.

Distal section assembly is coupled for translation in and out on intermediate section assembly. Refuse loading system 114 and/or refuse container emptying system 118 can be fully extended when intermediate section assembly is fully extended on base section assembly and distal section assembly is fully extended on intermediate section assembly. In the context of the present disclosure, “proximal” and “distal” are in reference to a distance from the body of the refuse vehicle, with “proximal” being relatively closer to the body of the vehicle and “distal” being relatively farther away from the body of the vehicle.

FIGS. 3A-3E are views of an example belt guide arrangement 300 that can be included in a refuse loading system (e.g., refuse loading system 114 in FIG. 1). FIG. 3A shows a front perspective view of the belt guide arrangement 300. FIG. 3B shows a front view of the belt guide arrangement 300. FIG. 3C shows a back perspective view of the belt guide arrangement 300. FIG. 3D shows a top view of the belt guide arrangement 300. FIG. 3E shows a perspective cross-sectional view of the belt guide arrangement 300.

According to various implementations, the belt guide arrangement 300 can be part of a belt system of a container lift mechanism (e.g., container lift mechanism 120 in FIG. 1). As previously mentioned, container lift mechanism 120 also includes mast 124. The belt system includes pulley 302 (shown in FIG. 3E), belt 126, drive unit(s) 128, and belt guide arrangement 300 (e.g., comprising belt guides 130). As discussed in further detail herein, belt guides 130 inhibit slippage of belt 126 relative to pulley 302.

Belt guide arrangement 300 includes a first belt guide 130a and a second belt guide 130b. Belt guides 130 are coupled with one or more other components of container lift mechanism 120. In some implementations, belt guides 130 are coupled with mast 124, e.g., as indicated in FIGS. 3A-3E. First belt guide 130a is attached to a first side of mast 124. Second belt guide 130b is attached to a second side of mast 124 that is opposite the first side of mast 124 relative to belt 126.

Pulley 302 is coupled with mast 124 and is rotatable about a rotational axis (e.g., rotational axis 304 in FIG. 3A). Drive unit(s) 128 are configured to drive pulley 302 so as to cause pulley 302 to rotate about rotational axis 304. Belt 126 engages with pulley 302 under tension such that rotation of pulley 302 causes movement of belt 126. A grabber system (e.g., grabber system 122) is attached to belt 126, e.g., such that grabber system 122 moves together with belt 126. Grabber system 122 is coupled to a portion of belt 126 that extends along a longitudinal axis of mast 124. A width of belt 126 (e.g., in a direction parallel to the rotational axis 304 of pulley 302) includes a first edge region 306, a second edge region 308, and a central region 310 (e.g., as indicated in the schematic front view of portion of belt 126 in FIG. 3C). The central region 310 of belt 126 extends between the first edge region 306 of belt 126 and the second edge region 308 of belt 126.

Grabber system 122 is attached to the central region 310 of belt 126. First belt guide 130a is positioned such that it overlaps the first edge region 306 of belt 126. Second belt guide 130b is positioned such that it overlaps the second edge region 308 of belt 126. In the direction parallel to the rotational axis 304 of pulley 302, first belt guide 130a and second belt guide 130b are spaced apart, e.g., as indicated in FIGS. 3A-3E.

First belt guide 130a and second belt guide 130b are part of a belt guide assembly, and the central region 310 of belt 126 is left uncovered by the belt guide assembly. The belt guide assembly is configured to limit movement of the belt 126 relative to the pulley 302, e.g., in a radial direction orthogonal to the rotational axis 304 of pulley 302.

Belt 126 includes a first side that engages pulley 302, and a second side facing away from pulley 302. First belt guide 130a has an underside proximate the first edge region 306 of belt 126. The second side of belt 126 (which faces away from pulley 302) and the underside of first belt guide 130a face each other. Similarly, second belt guide 130b has an underside proximate the second edge region 308 of belt 126. The second side of belt 126 (which faces away from pulley 302) and the underside of second belt guide 130b face each other.

According to some implementations, pulley 302 is a timing pulley, and belt 126 is a timing belt. The first side of the timing belt 126 comprises teeth that engage grooves of timing pulley 302. The teeth of timing pulley 302 have a tooth height in a direction orthogonal to the rotational axis 304 of timing pulley 302. The underside of first belt guide 130a is spaced apart from the second side of timing belt 126 by a first gap distance. Similarly, the underside of second belt guide 130b is spaced apart from the second side of timing belt 126 by a second gap distance. The first gap distance and the second gap distance can be the same distance in some implementations, but the first gap distance can be a different distance than the second gap distance in other implementations. According to some implementations, the first gap distance and/or the second gap distance are less than two times the tooth height dimension. In some examples, the first gap distance and/or the second gap distance are about 0.25 times the tooth height dimension.

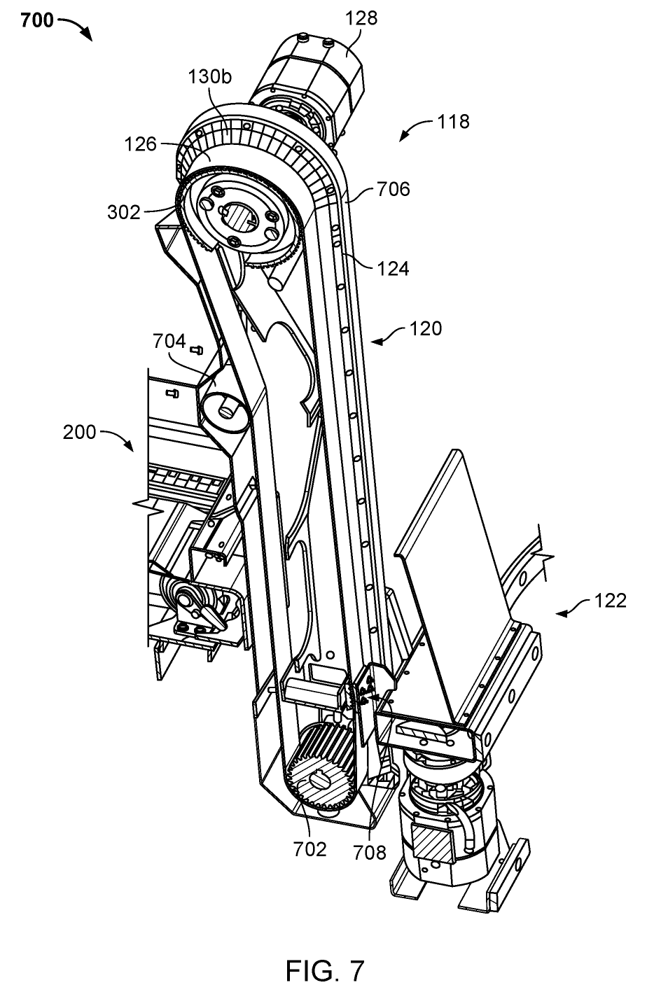

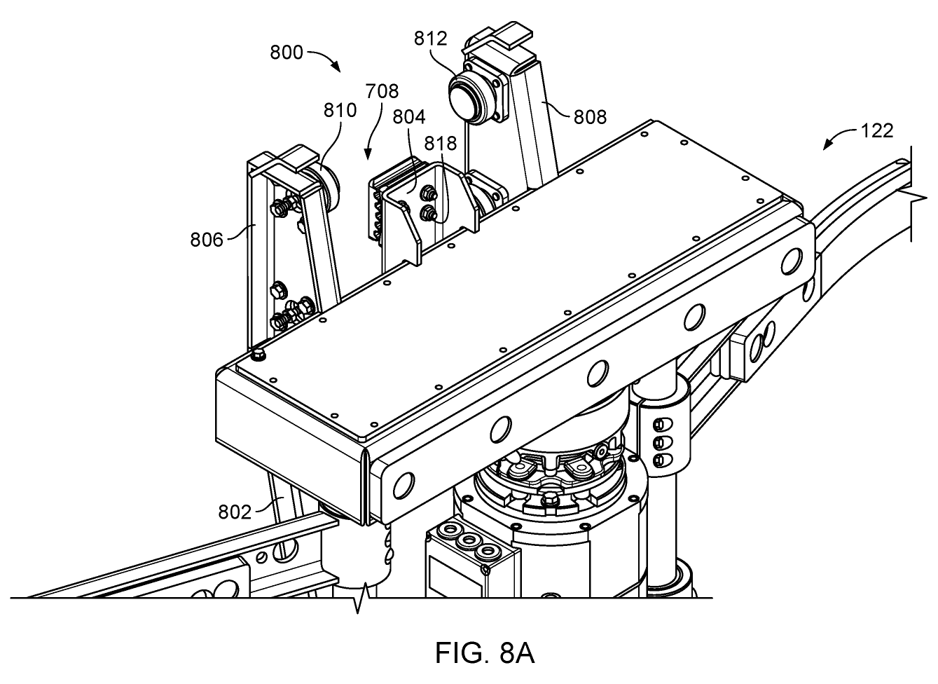

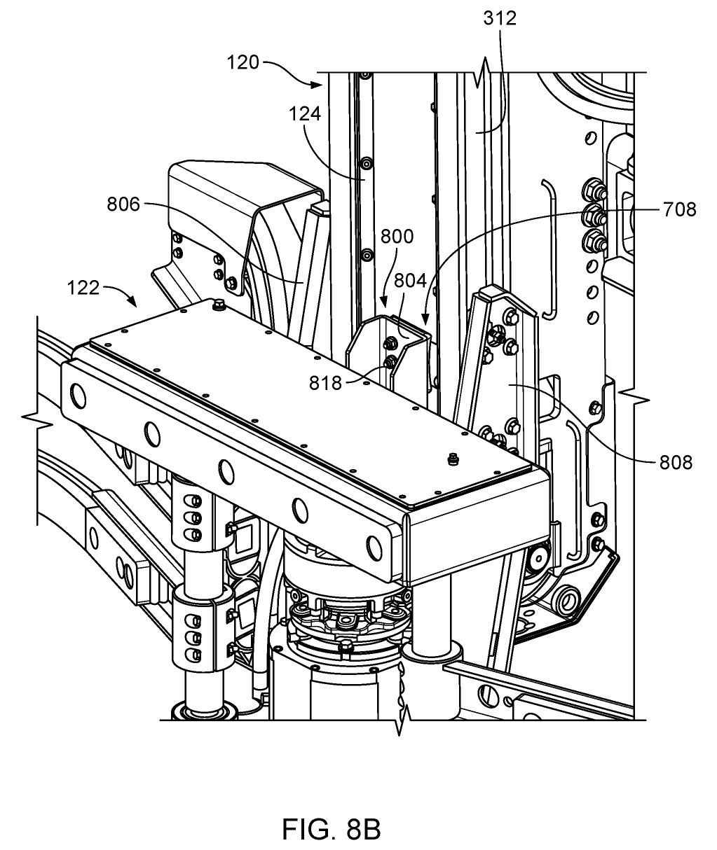

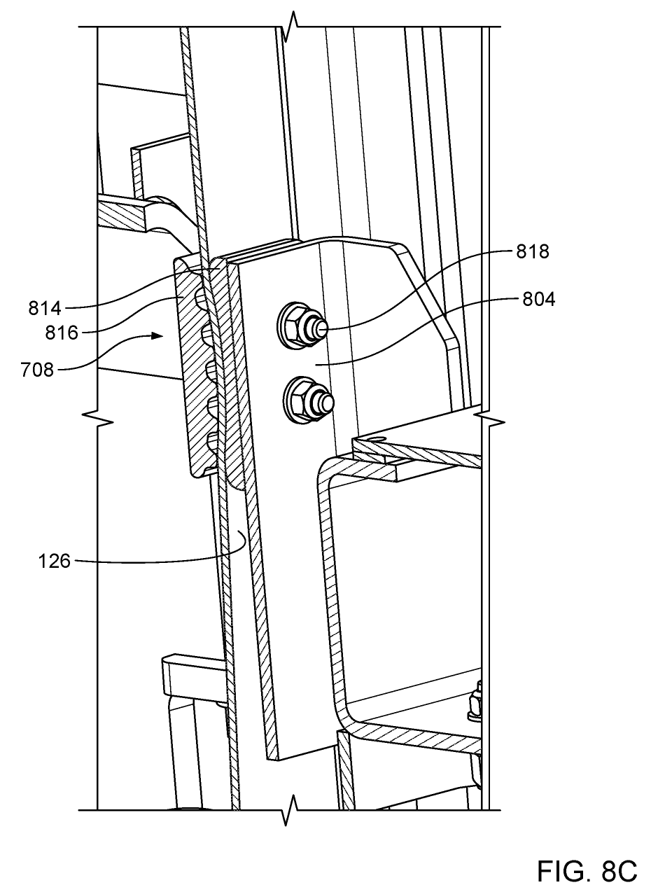

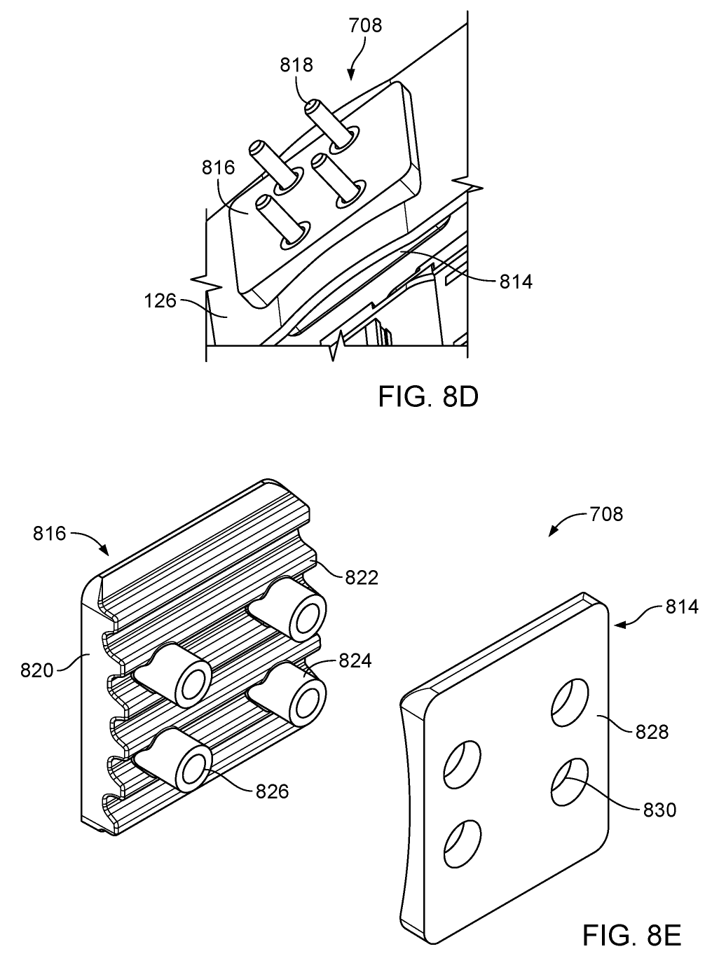

As will be discussed herein with reference to FIG. 7, mast 124 includes roller guides 312. Roller assemblies on either side of grabber system 122 roll in roller guides 312 of mast 124. A vertical drive unit (e.g., drive unit(s) 128) is operable to move belt 126 to raise and lower grabber system 122 on mast 124. As generally indicated by dashed box 312 in FIG. 3D, a roller on a first side of grabber system 122 engages a roller guide 312 on a first side of mast 124, e.g., proximate the first edge region 306 of belt 126 (and/or proximate first belt guide 130a). As generally indicated by dashed box 314 in FIG. 3D, a roller on a second side of grabber system 122 engages a roller guide 312 on a second side of mast 124, e.g., proximate the second edge region 308 of belt 126 (and/or proximate second belt guide 130b). As generally indicated by dashed box 316 in FIG. 3D, grabber system 122 is attached to the central region 310 of belt 126. An example attachment device that can be used to attach grabber system 122 to belt 126 is described herein with reference to at least FIGS. 7-8E.

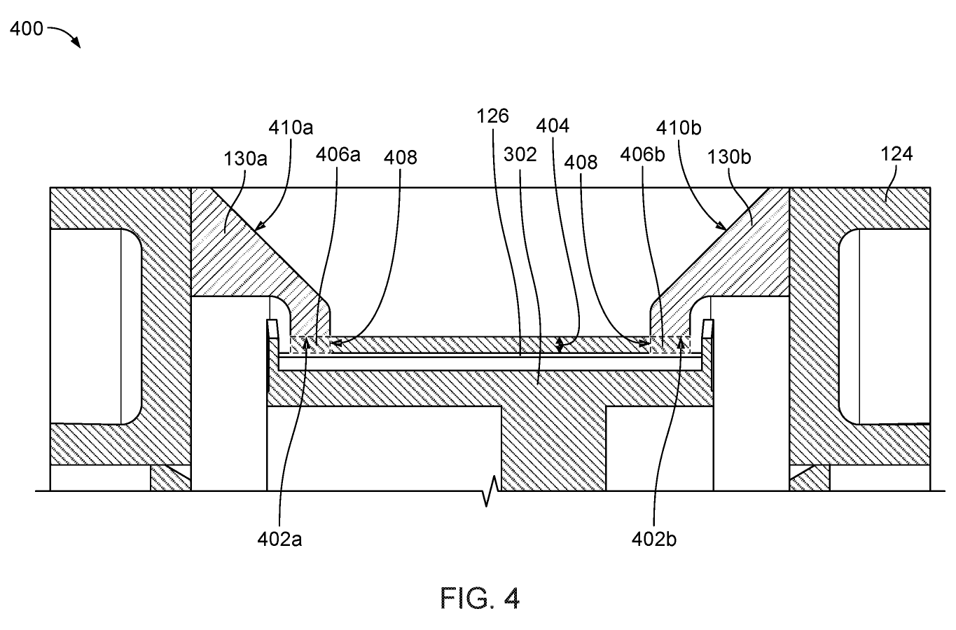

FIG. 4 is a schematic cross-sectional view of an example belt guide arrangement 400 that includes one or more interface elements, in accordance with some implementations. Belt guide arrangement 400 can be included in a refuse loading system (e.g., refuse loading system 114 in FIG. 1).

Belt guide arrangement 400 includes a first belt guide 130a and a second belt guide 130b. Belt guides 130 are coupled with one or more other components of container lift mechanism 120. In some implementations, belt guides 130 are coupled with mast 124, e.g., as indicated in FIG. 4. First belt guide 130a is attached to a first side of mast 124. Second belt guide 130b is attached to a second side of mast 124 that is opposite the first side of mast 124 relative to belt 126.

An underside 402a of first belt guide 130a and/or an underside 402b of second belt guide 130b is spaced apart from belt 126 by a gap distance (e.g., as indicated by gap dimension 404). Such belt guides 130 that are spaced apart from belt 126 can be referred to as non-contact belt guides. However, belt guides 130 can be in contact with belt 126 in other implementations.

A belt system includes interface element(s) 406 coupled with first belt guide 130a and/or second belt guide 130b. Interface element(s) 406 are one or more elements that provide a structural interface between a belt guide 130 and belt 126. As such, interface element(s) 406 can be in physical contact with belt 126. In some non-limiting examples, interface element(s) 406 can include a brush material, a gasket, and/or a ball bearing, etc. Interface element(s) 406 can be configured to prevent debris from entering an interior of the system, e.g., via possible debris paths indicated by arrows 408.

Interface element(s) 406a can be coupled with the underside 402a of first belt guide 130a. Additionally, or alternatively, interface element(s) 406b can be coupled with the underside 402b of second belt guide 130b. Dashed boxes are used to generally indicate example positioning of interface element(s) 406.

As indicated in FIG. 4, at least a portion of each of belt guides 130 is tapered. For example, first belt guide 130a is tapered with a first slanted side 410a having a negative slope. Second belt guide 130b is tapered with a second slanted side 410b having a positive slope. First belt guide 130a and second belt guide 130b form a spaced-apart V-shape. The tapered aspect of the belt guides 130 can help direct debris away from the edge regions of belt 126, which can help prevent debris from entering an interior portion of the system.

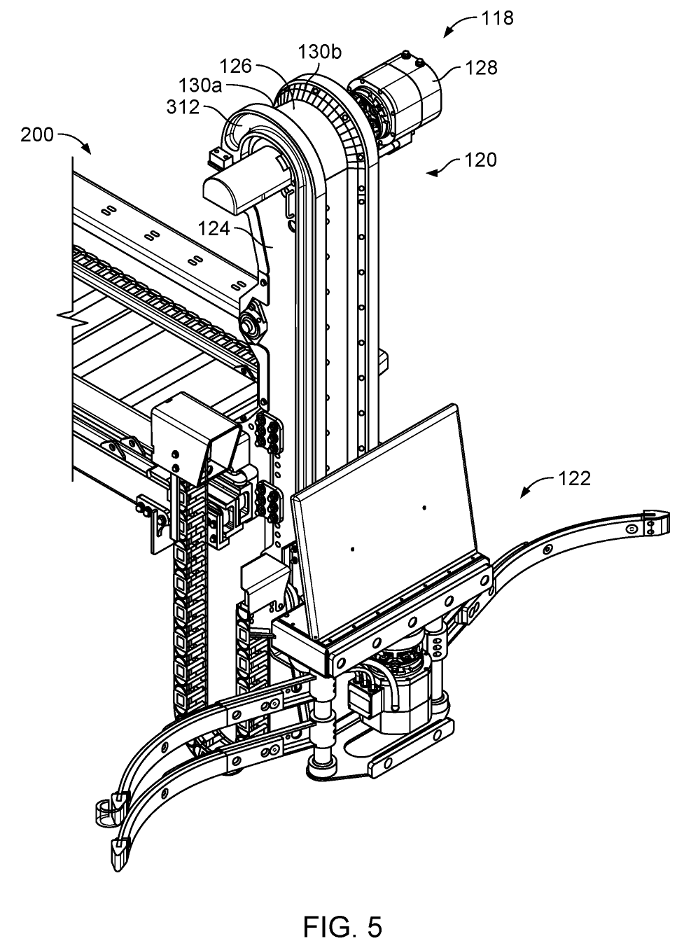

FIG. 5 is a perspective view of a refuse container emptying system (e.g., refuse container emptying system 118 in FIG. 1) that includes belt guides (e.g., belt guides 130 in FIG. 1). Refuse container emptying system 118 includes container lift mechanism 120 and grabber system 122. Grabber system 122 is coupled to container lift mechanism 120. Grabber system 122 is operable to couple to a refuse container. Container lift mechanism 120 can be bolted to a distal section assembly of horizontal positioning system 200. Container lift mechanism 120 is operable to lift the refuse container and tip and dump contents of the refuse container into a hopper (e.g., hopper 116 in FIG. 1).

Container lift mechanism 120 includes mast 124, a timing belt system, and vertical drive unit 128. Mast 124 includes roller guides 312. The timing belt system includes timing belt 126. Grabber system 122 is coupled to timing belt 126. In some implementations, grabber system 122 is secured to timing belt 126 by way of a belt attachment device (e.g., timing belt attachment device 708 in FIG. 7).

Vertical drive unit 128 is coupled to timing belt system. Vertical drive unit 128 is operable to move timing belt 126 to raise and lower grabber system 122 on mast 124.

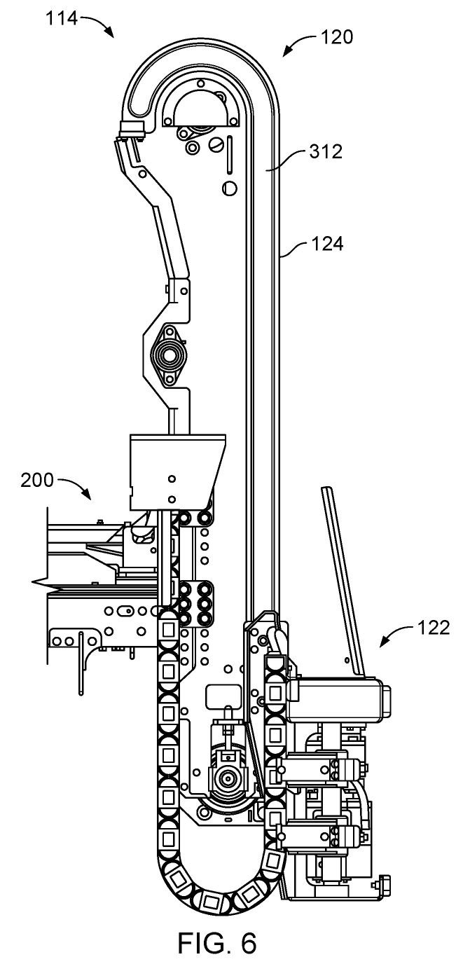

FIG. 6 is a side view of an example refuse container emptying system (e.g., refuse container emptying system 114 in FIG. 1) that includes belt guides (e.g., belt guides 130 in FIG. 1). A vertical drive unit (e.g., vertical drive unit 128 in FIG. 5) is operable to raise grabber system 122. Roller assemblies on either side of the grabber system 122 roll in roller guides 312 of mast 124. Initially, the grabber system 122 is raised straight up as roller assemblies travel through the straight portion of roller guides 312. As roller assemblies on either side of grabber system 122 pass into the curved upper portion of roller guides 312, the refuse container held in grabber system 122 partially inverts, tipping the refuse container such that its contents are dumped into a hopper (e.g., hopper 116 in FIG. 1) of the refuse vehicle.

FIG. 7 is a cross-sectional view of an example timing belt system 700 of a container lift mechanism (e.g., container lift mechanism 120 in FIG. 1) that includes belt guides (e.g., belt guides 130 in FIG. 1). Timing belt system 700 includes upper timing pulley 302, lower timing pulley 702, timing belt 126, and idler 704. Upper timing pulley 302 and lower timing pulley 702 are mounted between left and right main supports 706 of mast 124. Idler 904 promotes engagement of timing belt 126 with upper timing pulley 302 and lower timing pulley 902. Vertical drive unit 128 is operably connected to upper timing pulley 302. Grabber system 122 is attached to timing belt attachment device 708. Vertical drive unit 128 is operable to turn upper timing pulley 302. The front portion of timing belt 126 can be moved up on mast 124.

FIGS. 8A-8E illustrate an example connection 800 of a grabber system (e.g., grabber system 122 in FIG. 1) to a timing belt system (e.g., timing belt system 700 in FIG. 7) of a container lift mechanism (e.g., container lift mechanism 120 in FIG. 1) that can include belt guides (e.g., belt guides 130 in FIG. 1). FIG. 8A shows a perspective view of the grabber system and a belt attachment device (e.g., belt attachment device 708 in FIG. 7). FIG. 8B shows a perspective view of the grabber system connected to the timing belt system via the belt attachment device. FIG. 8C shows a perspective view of the belt attachment device connecting the grabber system to the timing belt system. FIG. 8D shows a perspective view of the belt attachment device on a timing belt. FIG. 8E shows an exploded view of the belt attachment device.

Grabber system 122 includes body 802, timing belt attachment member 804, left roller support 806, and right roller support 808. Left double roller assembly 810 is coupled to left roller support 806. Right double roller assembly 812 is coupled to right roller support 808. Each of left double roller assembly 810 and right double roller assembly 812 are engaged in roller guides 312 on either side of mast 124. Belt attachment device 708 couples timing belt attachment member 804 to timing belt 126, thus securing grabber system 122 to a section of timing belt 126.

As indicated in FIGS. 8C-8E, belt attachment device 708 includes front plate 814 and back plate 816. Back plate 816 has teeth that correspond to teeth on the timing belt 126 (in FIGS. 8C and 8D, the teeth on timing belt 126 are omitted for clarity). Fasteners 818 are installed in holes in timing belt attachment member 804, front plate 814, timing belt 126, and back plate 816. Fasteners 818 can be bolts with a corresponding nut.

As indicated in FIG. 8E, back plate 816 includes body 820, teeth 822, and bosses 824. Bosses 824 include through holes 826. Front plate 814 includes body 828 and through holes 830.

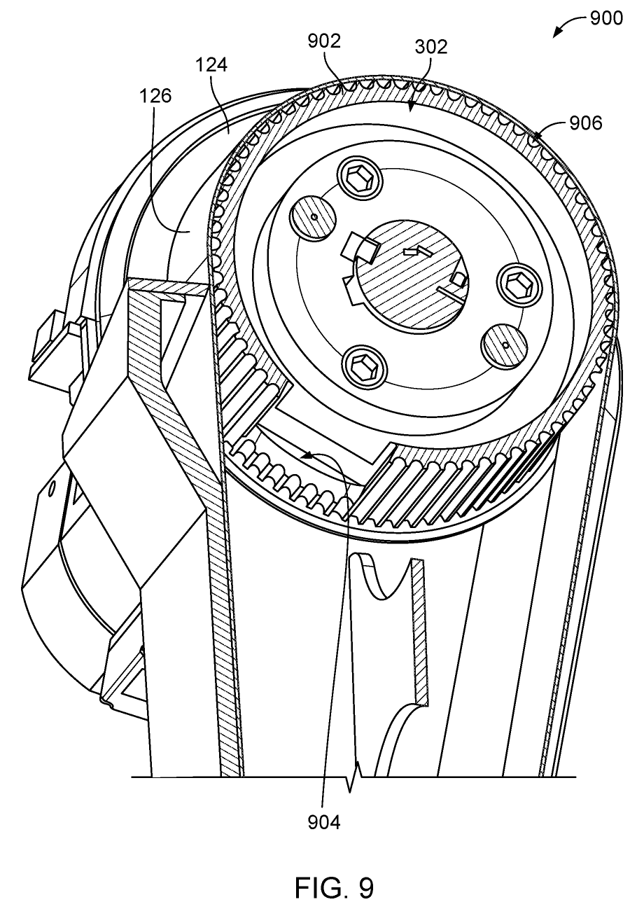

FIG. 9 is an example upper portion 900 of a timing belt system (e.g., timing belt system 700 in FIG. 7) of a refuse loading system (e.g., refuse loading system 114 in FIG. 1) with belt guides (e.g., belt guides 130 in FIG. 1), in accordance with some implementations. Upper timing pulley 302 is installed on mast 124. Upper timing pulley 302 includes teeth 902 and recess 904. Recess 904 accommodates belt attachment device 708 (shown in FIGS. 8A-8E) when grabber system 122 is raised on mast 124 to empty a refuse container. Upper timing pulley 302 can also be said to have grooves 906 (e.g., between teeth 902). Each groove 906 can correspond to a location in which a tooth of timing belt 126 is disposed when engaged with timing pulley 302.

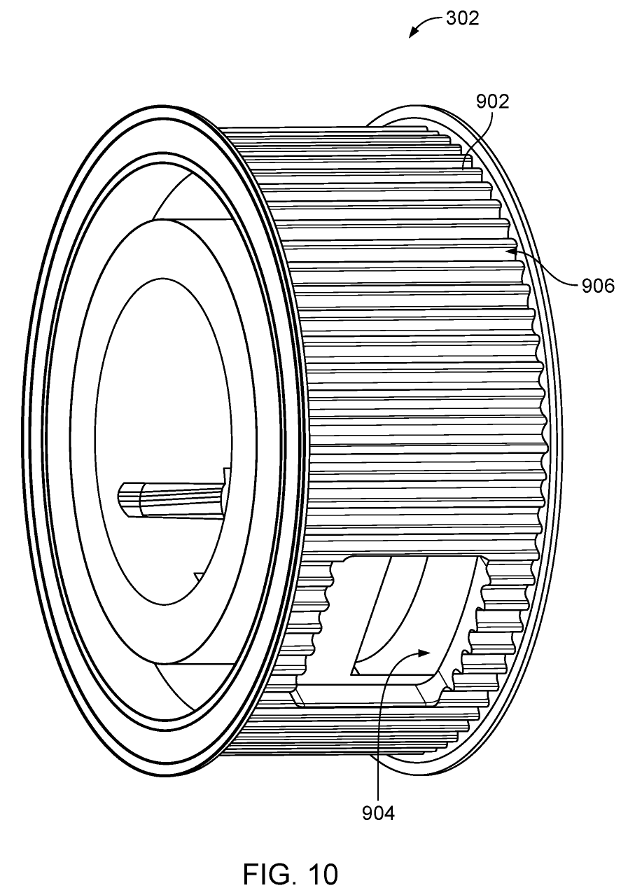

FIG. 10 is an example upper timing pulley (e.g., upper timing pulley 302 in FIG. 9) of a container lift mechanism (e.g., container lift mechanism 120 in FIG. 1) that can be included in a refuse loading system (e.g., refuse loading system 114 in FIG. 1) with belt guides (e.g., belt guides 130 in FIG. 1). Upper timing pulley 302 includes teeth 902 and recess 904. In the example shown in FIG. 10, recess 904 is a generally square opening that passes through the body of upper timing pulley 302. A recess can, however, have other shapes, such as circular, rectangular, ovate, etc. In some implementations, a timing pulley includes more than one recess.

In several of the figures included herein, a timing belt is depicted with the teeth of the timing omitted for clarity. In various implementations, however, the timing belt includes teeth that engage complementary teeth in an attachment device. Thus, for example, the teeth of the timing belt can match the pitch of the teeth of an attachment plate.

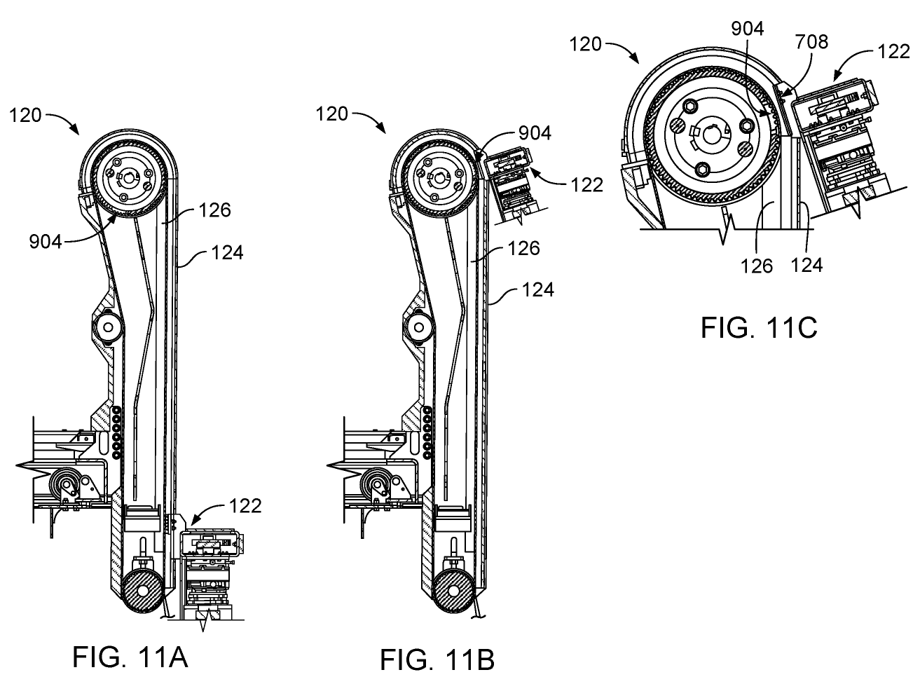

FIGS. 11A-11C illustrate an example of raising of a grabber system (e.g., grabber system 122 in FIG. 1) on a refuse container lift mechanism (e.g., refuse container lift mechanism 120 in FIG. 1) that can be included in a refuse loading system (e.g., refuse loading system 114 in FIG. 1) with belt guides (e.g., belt guides 130 in FIG. 1). Initially, grabber system 122 and belt attachment device 708 are at the bottom of mast 124 (FIG. 11A). The vertical drive unit (e.g., vertical drive unit 128 in FIG. 1) can be operated to move timing belt 126 such that grabber system 122 and belt attachment device 708 are raised on mast 124 (FIG. 11B).

The angular position of recess 904 on upper timing pulley 302 can be synchronized with the position of belt attachment device 708. When belt attachment device 708 reaches upper timing pulley 302, back plate 816 of belt attachment device 708 can enter recess 904 (best seen in FIG. 11C, which is a detail view of the upper portion of the FIG. 11B). In some implementations, clearance is maintained between the back plate 816 and upper timing pulley 302. In other implementations, a portion of the belt attachment device 708 (e.g., back plate 816) engages in recess 904. In such cases, a portion of the load of grabber system 122 and the refuse container can be transmitted through upper timing pulley 302 to mast 124. Engagement of an attachment device with a pulley of a belt drive system may increase stability of a refuse container emptying during emptying of the refuse container into the refuse vehicle.

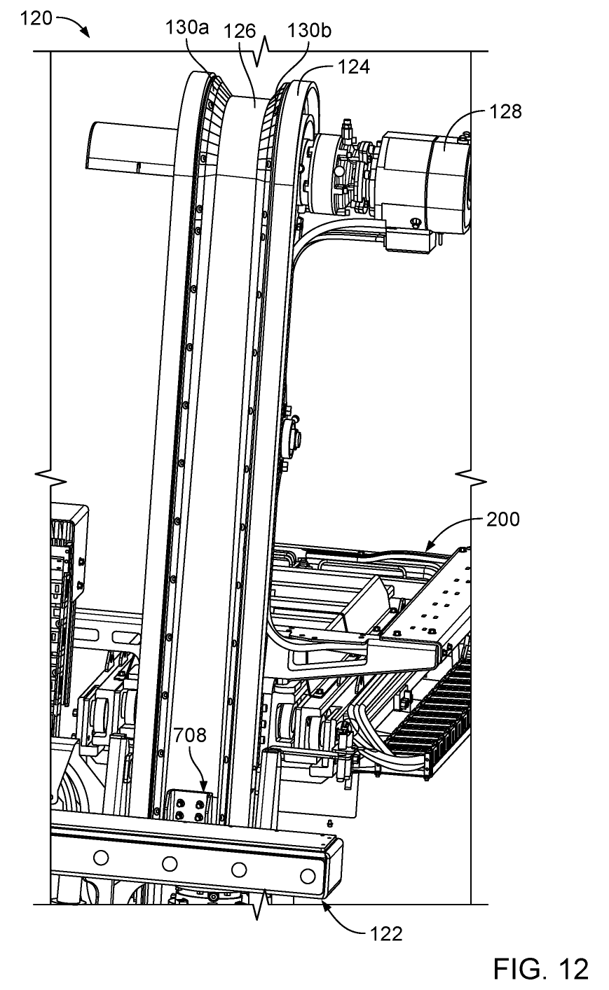

FIG. 12 is a perspective view of an example mast (e.g., mast 124 in FIG. 1) of a container lift mechanism (e.g., container lift mechanism 120 in FIG. 1) that can be included in a refuse loading system (e.g., refuse loading system 114 in FIG. 1) with belt guides (e.g., belt guides 130 in FIG. 1). Container lift mechanism 120 includes belt guides 130 mounted to mast 124 on each side of timing belt 126. In some implementations, belt guides 130 can be tapered such that the belt guides 130 form a spaced-apart V-shape. Belt guides 130 can help maintain timing belt 126 centered as belt attachment device 708 (and grabber system 122, which is attached to timing belt 126 via belt attachment device 708) are raised and lowered on mast 124.

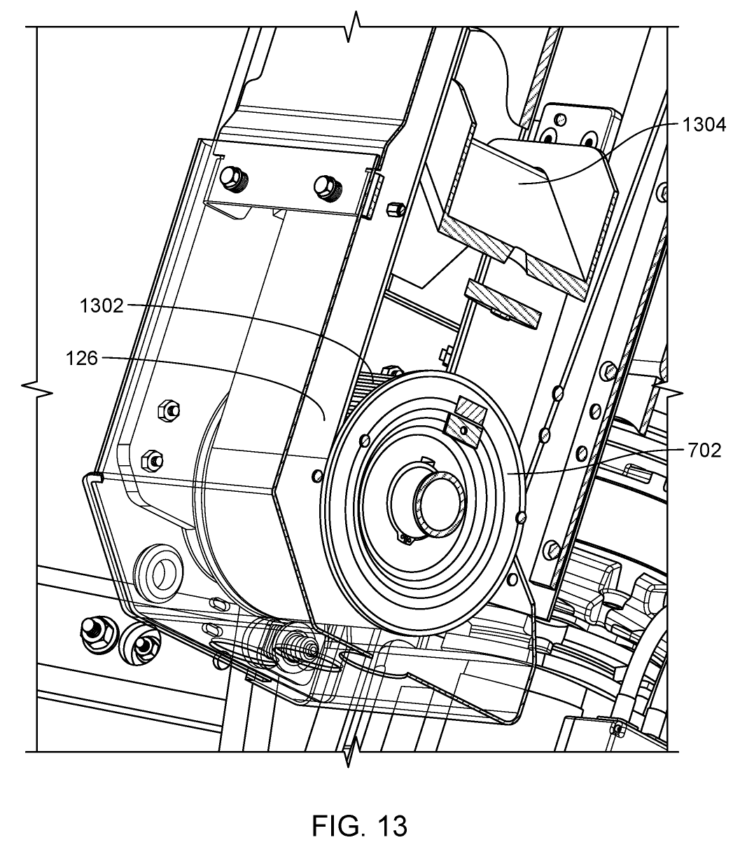

FIG. 13 is a cross-sectional view of an example lower timing pulley (e.g., lower timing pulley 702 in FIG. 7) of a container lift mechanism (e.g., container lift mechanism 120 in FIG. 1) that can be included in a refuse loading system (e.g., refuse loading system 114 in FIG. 1) with belt guides (e.g., belt guides 130 in FIG. 1). Timing belt 126 moves on lower timing pulley 702. The teeth on timing belt 126 engage on teeth 1302 on lower timing pulley 702. Timing belt system 700 can include a tensioning device. The tensioning device can change the position of lower timing pulley 702. In this manner, the tension of timing belt 126 can be adjusted by a user.

Container lift mechanism 120 includes lower timing pulley shield 1304 installed between the front side and rear sides of timing belt 126. Lower timing pulley shield 1304 protects lower timing pulley 702 from debris and contamination. Lower timing pulley shield 1304 can have an inverted vee shape.

Sensors can be included on various components of a refuse loading system (e.g., refuse loading system 114 in FIG. 1), including, for example, a grabber device (e.g., grabber 122 in FIG. 1). A refuse loading system can include other sensors. For example, a refuse loading system can include load sensors, proximity switches, position sensors, angle sensors, or pressure sensors. Operation of the refuse loading system or other systems can be controlled based on the information provided by the sensors. In some implementations, a refuse collection system includes sensors to sense position, angle, load, and/or other characteristics about the system. As an example, a sensor can sense position of component of a horizontal positioning system (e.g., a distal section or an intermediate section of horizontal positioning system 200 in FIG. 2). As another example, a sensor can sense position of a grabber system on a container lift mechanism (e.g., container lift mechanism 120 in FIG. 1). As another example, a grabber system can include a proximity switch that senses the position of an arm of a grabber or a refuse container.

Control of a refuse loading system may be carried out manually, automatically, or a combination thereof. In some implementations, a control system collects data from refuse collection system sensors and/or other operational sensors and controls the refuse loading system or other components of vehicle based on the information. For example, a control system may automatically shut down or reduce the speed of a drive system if a load (and/or another measured characteristic of the refuse vehicle’s system) is outside an established range or exceeds an established threshold.

In some implementations, torque, speed, and/or other parameters are adjusted based on the position, load, and/or other characteristics of one or more members of a refuse loading system. For example, in certain implementations, the torque of the motor, energy consumption, and/or other operating parameters are adjusted to account for different loads. Operation of refuse loading system for collecting recycled material can, for example, be different than operation of the loading system for collecting trash. In some implementations, the rate of motion of the reciprocating member can be controlled. In some implementations, a system includes interlocks to prevent unintended or un-commanded movement.

In some implementations, the control system receives position feedback from motor movement (e.g., using a sensored motor in time with the belt, position of in/out or up/down can be determined mathematically from rotation/partial rotation of motor and belt pitch).

In some implementations, belt slip is monitored. In one example, belt slip is monitored using end-of-travel position/sensors. As previously mentioned, belt guides (e.g., belt guides 130 in FIG. 1) described herein can be used to inhibit belt slippage.

In various implementations described above, devices are powered electrically. In certain implementations, however, devices used to operate components of a mechanism a refuse loading system (such as a grabber system lift arm, or a reciprocating member) can be activated or powered in other manners, such as pneumatically, mechanically, or hydraulically.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random-access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory may be supplemented by, or incorporated in, special purpose logic circuitry.

In various implementations described above, a system includes a timing pulley that is coupled to the output shaft of a motor. A refuse loading system can, in other implementations, include other drive unit arrangements that turn to drive element of the system. In some implementations, a drive unit of the packing device includes an outrunner/hub motor arrangement. In this implementation, the rotor of the electric motor is positioned outside the stator. In some implementations, a shell of an outrunner motor includes teeth, grooves, and/or other features on the outer surface of the shell that directly engage on a belt. In this case, a separate timing pulley can be omitted.

Implementations may be employed with respect to any suitable type of RCV, with any suitable type of body and/or hopper variants. For example, the RCV may be an automated side loader vehicle, such as described above with reference to FIG. 1. As another example, the RCV can be a commercial front loader (e.g., for dumpster type containers.) As another example, the RCV can be a residential front loader. A front loader can be provided with or without an intermediate collection device. The intermediate collection device can be used, for example, to collect residential-sized containers. In other implementations, the refuse vehicle may be a front-loading truck, a rear loading truck, a roll off truck, or some other type of garbage collection vehicle.

In some implementations described above, a timing belt in a refuse loading system as described herein is made of a polycarbonate material. In some implementations, the timing belt has a 14 mm pitch.

In various implementations described above, a refuse loading system includes timing belt drive systems. Similar guides can be used with other types of belt drives (e.g., those including v-belts, ribbed belts, and/or other belts that have longitudinal contact surfaces). In those instances, the guides would be closer to the belt to ensure the friction surfaces do not separate (e.g., mitigating “slip” instead of “skip” in some implementations). In some implementations, a refuse loading system can include other types of flexible tether systems, such as those that include a chain, a band, a cable, and/or a rope, etc. Similar guides to the belt guides described herein can be used for such other types of flexible tether systems. For example, a chain guide can be used or a chain drive to prevent the chain from skipping a tooth of a corresponding sprocket. In one non-limiting example, a guide can be used in a double-row chain arrangement. According to this example, an implement/fixture is coupled with a first chain (one row) of the two rows of chains, such that the implement/fixture moves with the first chain, and the guide is positioned to cover the second chain (the other row) of the two rows of chains. In another non-limiting example, guides can be used in a triple-row chain arrangement. According to this example, an implement/fixture is coupled with a first chain (a central row) of the three rows of chains, such that the implement/fixture moves with the first chain, and a respective guide is positioned to cover each of a second chain and a third chain (outer rows) of the three rows of chains, the outer rows being on opposing sides of the central row. In addition, a refuse loading system can, in some implementations, include other types of drive mechanisms, such as a hydraulic drive, a direct drive, and/or a linear motor, etc.

As used herein, a “drive unit” includes any device, mechanism, or system that imparts force to mechanically drive one or more components. Examples of a drive unit include a hydraulic motor, an electric motor, or an engine. A driver may also include gearboxes, belts, chain drives, or other power transmission devices.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the disclosure. Accordingly, other implementations are within the scope of the following claim(s).

1. A system for loading refuse, the system comprising:
a grabber system operable to engage a refuse container; and
a container lift mechanism configured to couple between the grabber system and a refuse collection vehicle and operable to lift the refuse container held by the grabber system, the container lift mechanism comprising:
a mast; and
a belt system, comprising:
a pulley coupled with the mast, the pulley rotatable about a rotational axis; and
a belt engaged with the pulley, wherein the grabber system is coupled to a portion of the belt that extends along a longitudinal axis of the mast, and wherein a width of the belt, in a direction parallel to the rotational axis of the pulley, comprises:
a first edge region;
a second edge region; and
a central region extending between the first edge region and the second edge region;
one or more drive units configured to drive the belt system such that the pulley rotates and moves the belt, wherein the grabber system is configured to move together with the belt;
a first belt guide overlapping the first edge region of the belt; and
a second belt guide overlapping the second edge region of the belt, wherein, in the direction parallel to the rotational axis of the pulley, the first belt guide and the second belt guide are spaced apart by a gap.

2. The system of claim 1, wherein the belt system comprises a belt guide assembly that includes the first belt guide and the second belt guide, and wherein the central region of the belt is not covered by the belt guide assembly.

3. The system of claim 2, wherein the belt guide assembly limits movement of the belt, relative to the pulley, in a radial direction orthogonal to the rotational axis of the pulley.

4. The system of claim 1, wherein:
the belt comprises:
a first side that engages the pulley; and
a second side facing away from the pulley;
the first belt guide comprises an underside proximate the first edge region; and
the second side of the belt and the underside face each other.

5. The system of claim 4, wherein:
the pulley is a timing pulley;
the belt is a timing belt; and
the first side of the timing belt comprises teeth that engage grooves of the timing pulley.

6. The system of claim 5, wherein the teeth have a tooth height dimension in a direction orthogonal to the rotational axis, and wherein the underside of the first belt guide is spaced apart from the second side of the timing belt by a gap distance that is less than the tooth height dimension.

7. The system of claim 5, wherein the underside of the first belt guide is in contact with the second side of the timing belt.

8. The system of claim 5, wherein the belt system further comprises an interface element coupled with the underside of the first belt guide, the interface element being configured to provide a barrier that inhibits the ingress of debris into at least a portion of the belt system.

9. The system of claim 8, wherein the interface element comprises a brush material.

10. The system of claim 8, wherein the interface element comprises a gasket.

11. The system of claim 8, wherein the interface element comprises a ball bearing.

12. The system of claim 5, wherein:
the timing pulley is a first timing pulley; and
the belt system further comprises a second timing pulley coupled to the mast and located below the first timing pulley.

13. The system of claim 5, wherein the grabber system is fixedly attached to the central region of the timing belt.

14. The system of claim 13, wherein the mast further comprises vertical rails comprising guides configured to guide the grabber system on the mast, the vertical rails comprising:
a first vertical rail proximate the first edge region of the timing belt; and
a second vertical rail proximate the second edge region of the timing belt.

15. The system of claim 1, wherein the first belt guide and the second belt guide are tapered such that they form a spaced-apart V-shape.

16. A refuse collection vehicle, comprising:
a cab;
a vehicle chassis coupled to the cab;
a refuse body coupled to and supported on the vehicle chassis, the refuse body comprising:
a refuse collecting space; and
a refuse loading system for loading refuse into the refuse collecting space, the refuse loading system comprising:
a grabber system operable to engage a refuse container; and
a container lift mechanism configured to couple between the grabber system and the refuse collection vehicle and operable to lift the refuse container held by the grabber system, the container lift mechanism comprising:
a mast; and
a belt system, comprising:
a pulley coupled with the mast, the pulley rotatable about a rotational axis; and
a belt engaged with the pulley, wherein the grabber system is coupled to a portion of the belt that extends along a longitudinal axis of the mast, and wherein a width of the belt, in a direction parallel to the rotational axis of the pulley, comprises:
a first edge region;
a second edge region; and
a central region extending between the first edge region and the second edge region;
one or more drive units configured to drive the belt system such that the pulley rotates and moves the belt, wherein the grabber system is configured to move together with the belt;
a first belt guide overlapping the first edge region of the belt; and
a second belt guide overlapping the second edge region of the belt, wherein, in the direction parallel to the rotational axis of the pulley, the first belt guide and the second belt guide are spaced apart by a gap.

17. The refuse collection vehicle of claim 16, wherein the belt system comprises a belt guide assembly that includes the first belt guide and the second belt guide, and wherein the central region of the belt is not covered by the belt guide assembly.

18. The refuse collection vehicle of claim 16, wherein:
the belt comprises:
a first side that engages the pulley; and
a second side facing away from the pulley;
the first belt guide comprises an underside proximate the first edge region; and
the second side of the belt and the underside face each other.

19. The refuse collection vehicle of claim 18, wherein:
the pulley is a timing pulley;
the belt is a timing belt; and
the first side of the timing belt comprises teeth that engage grooves of the timing pulley.

20. The refuse collection vehicle of claim 19, wherein the teeth have a tooth height dimension in a direction orthogonal to the rotational axis, and wherein the underside of the first belt is spaced apart from the second side of the timing belt by a gap distance that is less than the tooth height dimension.
